(19) United States
(12) Patent Application Publication
(10) Pub. No.: US 2009/0067085 A1
(43) Pub. Date: Mar. 12, 2009

(54) ACTUATOR SHROUD

(75) Inventors: Hany Michael Gross, Eden Prairie, MN (US); Yimin Niu, Eden Prairie, MN (US); Jess Brandon Pool, Lakeville, MN (US); Fei Peter Wang, Savage, MN (US); Michael Allen Mewes, Belle Plaine, MN (US); Jason Daniel Graham, White Bear Lake, MN (US); Ning Yu, Eden Prairie, MN (US)

Correspondence Address: SEAGATE TECHNOLOGY LLC C/O WESTMAN;CHAMPLIN & KELLY, P.A., SUITE 1400, 900 SECOND AVENUE SOUTH, MINNEAPOLIS, MN, 55402-3244, US

(73) Assignee: Seagate Technology LLC, Scotts Valley, CA (US)

(21) Appl. No.: 11/850,926

(22) Filed: Sep. 6, 2007

(51) Int. Cl. G11B 33/14

(52) U.S. Cl. 360/97.02

(57) ABSTRACT

Devices are provided herein in a variety of examples that inhibit particle pickup and transport and mechanical vibrations and provide other advantages. In one illustrative example, an actuator assembly includes a base, an actuator disposed on the base, and a shroud disposed on the base around the actuator. The shroud includes one or more shroud walls disposed between the actuator and a flow channel exterior to the shroud. The shroud walls may include shielding walls that partially surround the actuator, radially curved shroud wall segments, fastener well shields that substantially separate an interior thereof from the actuator, and other aspects. A data storage device may have a flow path defined therein, and the shroud may be disposed around an actuator within the data storage device, providing a streamlined surface between the flow path and the actuator.

### BACKGROUND

The reliable operation of data storage devices is a top priority, and has been a persistent challenge as the elements of data storage have grown progressively smaller. Experimental data show that major failure modes in reliably interfacing with small areas of data storage are caused by aerodynamic turbulence buffeting the discs and actuator, and by microscopic particles within a data storage device, which may interfere with or damage components such as a media surface or a slider with a read and/or write head suspended adjacent to such a media surface.

As a particular example, aluminum particles on the scale of five to ten microns (i.e. micrometers) and having jagged edges have been found fairly regularly to be interfering with reliable interfacing with data storage media surfaces within data storage devices. Such particles may arise in the manufacturing process. In an illustrative data storage device involving a disc drive, for example, such particles may arise in the area of an actuator mechanism, and in particular in the area of one or more screws used to fasten the actuator mechanism within the disc drive. The generating of such particles may be promoted by repeated fastening and unfastening of such screws. Often, a manufacturing process involves automated quality assurance testing of a newly assembled disc drive, identification of any defective components, and then disassembly of the drive, replacement of the defective component, reassembly, and repetition of the testing, until all components are confirmed to be operating within desirable parameters. For example, one disc in the middle of a disc stack may be found to be defective during quality assurance testing, in which case a disc drive may be re-opened, the actuator assembly unfastened and removed, the discs above the defective disc removed to get to the defective disc, and then the defective disc removed and replaced with another disc, before the remaining discs are put back in place and the actuator mechanism is re-fastened into place. Each repetition of this process may provide additional opportunities for microscopic particles to be generated within the disc drive, which have the potential to interfere later with the reading and/or writing of data within the drive.

The present disclosure provides solutions to these and other problems and offers other advantages over the prior art. The discussion above is merely provided for general background information and is not intended to be used as an aid in determining the scope of the claimed subject matter.

### SUMMARY

One illustrative aspect of the present disclosure is directed to an actuator assembly that includes a base, an actuator disposed on the base, and a shroud disposed on the base around the actuator. The shroud includes one or more shroud walls disposed between the actuator and a flow channel exterior to the shroud.

### BRIEF DESCRIPTION OF THE DRAWINGS

FIG. 1 depicts a top plan schematic view of a data storage device that includes an actuator shroud, in accordance with one illustrative example.

FIG. 2 depicts a top plan schematic view of a data storage device that includes an actuator shroud, in accordance with another illustrative example.

FIG. 3 depicts a perspective view of an actuator shroud, in accordance with one illustrative example.

FIG. 4 depicts a perspective view of an actuator shroud, in accordance with another illustrative example.

FIG. 5 depicts a top plan schematic view of a data storage device that includes an actuator shroud, including a depiction of hydrodynamic flow velocity contours, in accordance with one illustrative example.

### DETAILED DESCRIPTION

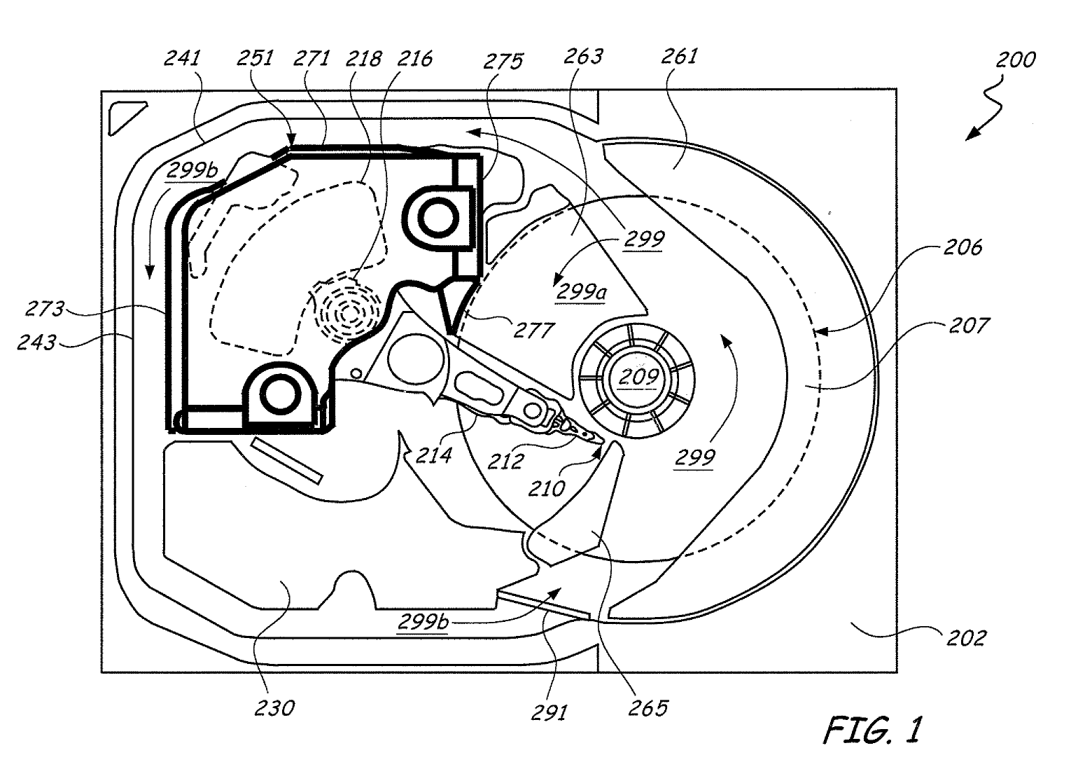

An actuator shroud 251 is provided in data storage system 200, as depicted in FIG. 1. Actuator shroud 251 constrains aerodynamic flow and inhibits the internal transport of microscopic debris, thereby promoting superior mechanical precision, cleanliness, and overall superior functioning of the data storage system, among a variety of performance advantages.

Various shielding walls of actuator shroud 251 define an interior of the actuator shroud within which components such as an actuator 216 and voice coil motor 218 may be situated. The shielding walls contribute to configuring actuator shroud 251 to significantly separate the shroud interior, containing the actuator 216, from a remaining interior portion of the data storage system 200 exterior to the shroud, as in the illustrative example of FIG. 1, for example. Any debris associated with the actuator 216, voice coil motor 218, or associated components, or from the assembly or subsequent removal and reinsertion thereof, may thereby be trapped within the interior portion of the shroud and isolated from the exterior portion constituting the remainder of a data storage device. The isolation thereby provided by the actuator shroud 251 inhibits the capacity of any debris that might escape other cleaning techniques, from later being transported into the disc stack 206 and interfering with the surfaces of the discs 207 or their interface with the read/write mechanisms of the system.

Actuator shroud 251 also confines the airflow generated by the discs 207, thereby reducing the flow fluctuations at the edges of the discs in the vicinity of actuator shroud 251, which reduces vibration of the discs 207. This reduction in disc vibrations consequently reduces non-repeatable run-out errors of the read and/or write heads on sliders suspended in proximity to the surfaces of discs 207, in this illustrative example.

As yet another advantageous feature, as actuator shroud 251 partially shields both the actuator 216 and the voice coil motor 218, and thereby inhibits the turbulent flow of air impinging on the actuator and the voice coil motor, actuator shroud 251 also reduces mechanical disturbances and vibrations experienced by the actuator 216 and the voice coil motor 218 themselves. These effects promote reliable mechanical precision in the performance of actuator 216 in positioning the read and/or write heads with respect to the surfaces of discs 216, thereby further reducing non-repeatable run-out errors of the read and/or write heads. Each of these advantages may be provided by a wide variety of actuator shrouds that are not limited to the particular characteristics or components of actuator shroud 251, but may include many other configurations.

Data storage system 200 can be configured as a traditional magnetic disc drive, a magneto-optical disc drive or an optical disc drive, for example. An actuator shroud may also be advantageously applied to a wide variety of other types of systems in which an actuator operates in an environment in which hydrodynamic flow or environmental cleanliness affect performance characteristics, for example.

Disc stack 206 includes a plurality of individual discs 207, which are mounted for co-rotation about central axis 209. In the example depicted in FIG. 1, one or more sliders 210 are each supported by a suspension 212 over a corresponding disc surface, and carries a read and/or write head for reading data from and/or writing data to the respective disc surface. Each suspension 212 is in turn attached to a track accessing arm 214 of an actuator 216. The actuator 216 shown in FIG. 1 is of the type known as a rotary moving coil actuator and includes a voice coil motor (VCM), shown generally at 218. Voice coil motor 218 rotates actuator 216 with its attached sliders 210 about a pivot shaft to position sliders 210 over a desired data track in the corresponding disc surface. Voice coil motor 218 operates under control of internal circuitry 230. Other types of actuators can also be used, such as linear actuators, for example.

During operation, as discs 207 rotate, the discs drag air (or other fluid) under the respective sliders 210 and along their bearing surfaces in a direction approximately parallel to the tangential velocity of the discs. As the air (or other fluid) passes beneath the bearing surfaces, fluid compression along the flow path causes the fluid pressure between the discs and the bearing surfaces to increase, which creates a hydrodynamic lifting force that counteracts the load force provided by suspensions 212 and causes the sliders 210 to lift and fly above or in close proximity to the disc surfaces. In other examples such as in contact recording, the bearing surfaces remain in contact with the disc surfaces.

The motion of the air (or other fluid) caused by the rotation of disc stack 206 also sets up a cyclic current of air throughout the data storage device 200, which generally tracks with the rotational motion of the discs 207 within the disc stack 206, and also flows turbulently through the remaining free space within the data storage device 200, generally around and between internal components such as actuator 216, voice coil motor 218, and internal circuitry 230, except as restrained by actuator shroud 251. This air current is capable of transporting microscopic debris from those other areas of the disc drive into the disc stack 206, where it could potentially mechanically disturb the surfaces of discs 207, the sliders 210, and/or the interface between the two, except as restrained by actuator shroud 251. Although the data storage device 200 is typically manufactured under cleanroom conditions that inhibit the presence of microscopic debris in a disc drive, the absolute absence of such material is difficult to achieve, and small samples of such debris may be generated during the process of assembling the data storage device 200. Actuator shroud 251 effectively counteracts such debris by inhibiting the pickup and transport of debris particles in the airflow from the vicinity of the actuator to the surfaces of the discs.

Actuator shroud 251 is disposed on base 202 in the vicinity of, and partially surrounding, actuator 216 and voice coil motor 218, which are also disposed on base 202, in the illustrative example of FIG. 1. Actuator shroud 251 includes shroud walls disposed between the region proximate to actuator 216 and voice coil motor 218 in the interior of actuator shroud 251, and the region exterior to actuator shroud 251, which is occupied by the main flow path 299 of the air flow being generated through data storage device 200 by the rotational motion of disc stack 206, which includes one or more discs that are rotatably mounted on base 202.

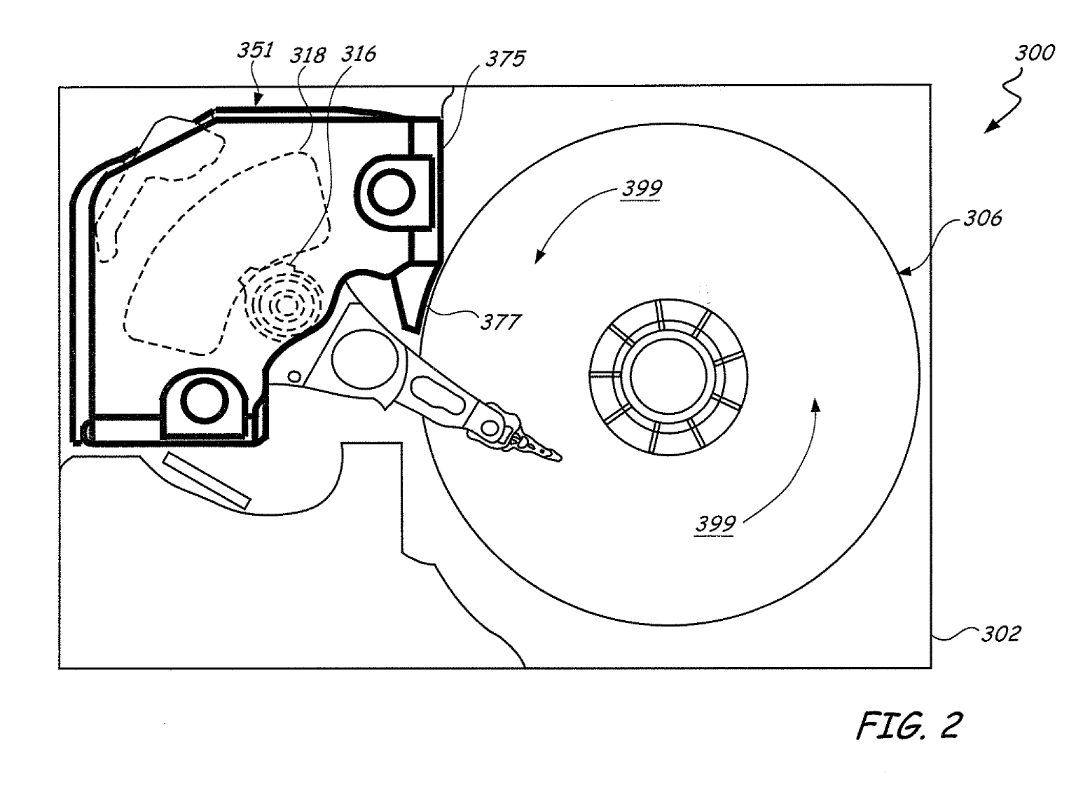

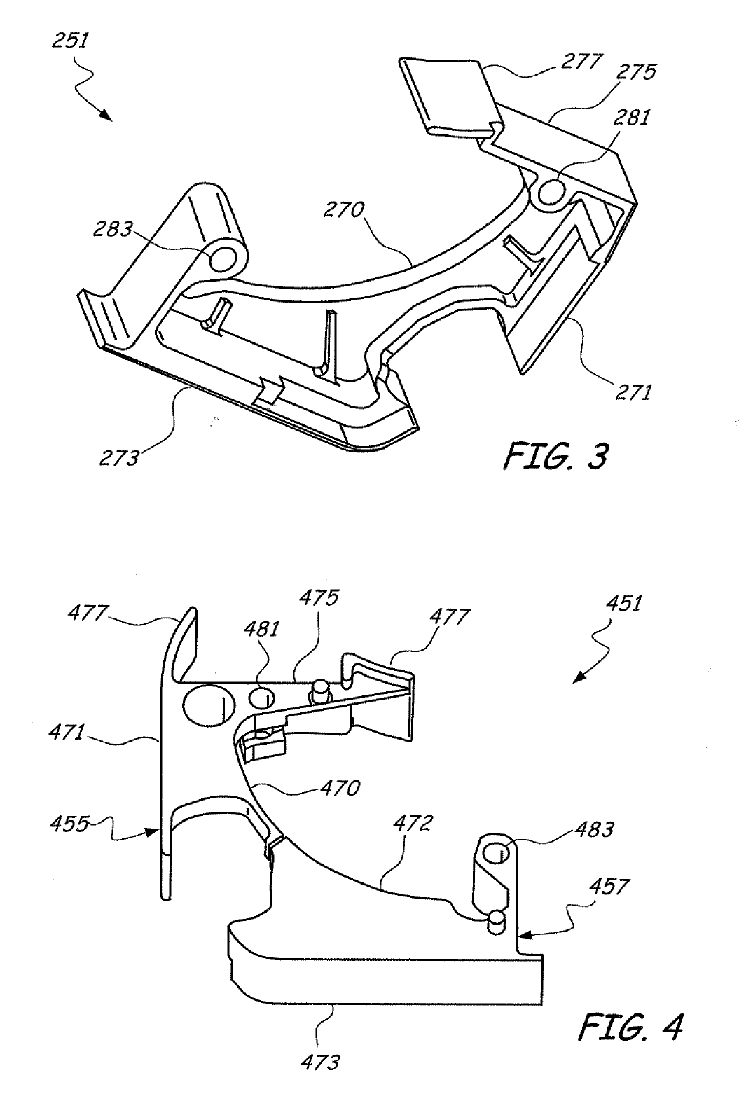

The shroud walls of actuator shroud 251 include shielding walls 271, 273, 275, and radially curved shroud wall segment 277, each of which has a streamlined exterior surface, in this illustrative example. Shroud wall segment 277 is radially curved in substantial conformity with the radial perimeter of disc stack 206, and disposed substantially adjacent to the disc stack 206, to contribute to separating the flow path that remains within disc stack 206 from the interior of actuator shroud 251. The shroud walls of actuator shroud 251 are further depicted in perspective view in FIGS. 2 and 3 below.

Several instances of flow path 299 are depicted in FIG. 1, along portions of its generally bifurcated circuitous path through data storage device 200. Flow path 299 is bifurcated in that a portion of the air flow 299a remains within a flow path within disc stack 206, while a portion of the air flow 299b passes through a bypass flow channel around actuator shroud 251 and internal circuitry 230, bounded on the inside of its path by the actuator shroud's shielding walls 271, 273 and on the outside of its path by base walls 241, 243 as the air flow passes generally around a perimeter of data storage device 200 before passing through air flow recirculation filter 291 to re-enter disc stack 206. Shielding walls 271, 273 therefore contribute to defining a bypass flow channel that directs a streamlined flow path around the perimeter of actuator shroud 251, and shielding walls 275, 277 contribute to defining a flow channel in the vicinity of disc stack 206 that directs another streamlined flow path around a different section of the perimeter of actuator shroud 251. In both cases, the shielding walls provided by actuator shroud 251 are disposed between the actuator 216 and a flow channel exterior to the shroud 251, thereby inhibiting pickup and transport of debris particles in the disc drive.

Among the other innovations in FIG. 1 are additional mechanisms for controlling the flow of air within data storage device 200, including disc stack shrouds 261, 263, and 265, disposed in proximity to and in between the discs 207 within disc stack 206 and which aerodynamically control the flow of air among the discs 207, providing aerodynamic control that is complementary to that of actuator shroud 251. In particular, disc stack shrouds 261 and 263 direct the flow path into the general direction of the streamlined shielding walls comprised in the actuator shroud 251 on one side, and of the base wall 253 on the other side, resulting in a less turbulent, more directed air flow between disc stack 206 and the exterior of actuator shroud 251.

While shroud wall 251 is depicted with certain details in FIG. 1, this represents only one illustrative example out of a range of various potential configurations. As an example, while actuator shroud 251 is depicted as being disposed on base 202, this may include actuator shroud 251 being disposed on a magnet plate that is itself disposed on base 251, and which contributes to the function of voice coil motor 218. In yet another aspect, the actuator shroud may be attached to a top cover (not depicted in FIG. 1) that is disposed over base 202.

Data storage device 300 of FIG. 2 is similar in many respects to data storage device 200 of FIG. 1, and also includes an actuator shroud 351. Data storage device 300 differs from data storage device 200 of FIG. 1 in some aspects of its configuration, such as in its lack of a bypass flow channel, while actuator shroud 351 provides shielding from the flow path 399 in the vicinity of the disc stack 306. Actuator shroud 351 is disposed on base 302 in the vicinity of, and partially surrounding, actuator 316 and voice coil motor 318, which are also disposed on base 302, in the illustrative example of FIG. 2. Actuator shroud 351 includes shroud walls disposed between the region interior to actuator shroud 351, where actuator 316 and voice coil motor 318 are situated, and the region exterior to actuator shroud 351, which includes the flow path 399 of the air flow being generated through data storage device 300 and around a section of actuator shroud 351 by the rotational motion of disc stack 306.

The shroud walls of actuator shroud 351 include shielding wall 375 and radially curved shroud wall segment 377, each of which has a streamlined exterior surface, in this illustrative example. Shroud wall segment 377 is radially curved in substantial conformity with the radial perimeter of disc stack 306, and both shielding wall 375 and shroud wall segment 377 are disposed substantially adjacent to the disc stack 306, and contribute to separating the flow path 399 within disc stack 306 from the interior of actuator shroud 351. Shielding walls 375, 377 provided by actuator shroud 351 are thereby disposed between the actuator 316 and flow path 399 exterior to the shroud 351, thereby inhibiting pickup and transport of debris particles in the disc drive, in accordance with another illustrative embodiment.

FIG. 3 depicts a perspective view of illustrative actuator shroud 251 of FIG. 1 by itself; according to an illustrative example consistent with that depicted in FIG. 1 within the context of data storage system 200. Actuator shroud 251 is depicted in FIG. 3 in perspective view from the underside, looking at an angle toward the portion of the shroud that would face downward toward base 202 in FIG. 1. Actuator shroud 251 may be formed by injection-molded plastic, in one illustrative example, or by other forms of plastic, any of various metals, or other substances, in other configurations.

FIG. 3 provides a more detailed depiction of actuator shroud 251 and its shroud walls, including shielding walls 271, 273 and radially curved shroud wall segment 277 as seen in FIG. 1. The shroud walls also include shielding wall 275, which is disposed between the actuator and the disc stack, and from which shroud wall segment 277 extends, which itself is also disposed between the actuator and the disc stack. These various shielding walls may serve to constrain and laminarize aerodynamic paths and restrain the internal transportation of microscopic debris within a data storage system, as discussed above.

Actuator shroud 251 further includes support portion 270, which spans between and connects the various shroud walls 271, 273, 275, 277. Support portion 270 partially covers over the top of the actuator and voice coil motor within data storage system 200 in FIG. 1, and may be positioned adjacent to a top cover that is disposed over base 202 in the data storage system 200 of FIG. 1. Support portion 270 may have reinforced joints and spars supporting its structure and its attachments with the various shroud walls 271, 273, 275, 277, as shown.

Actuator shroud 251 also includes fastener well shields 281, 283, through which fastener components may be inserted and joined with base 202 to attach actuator shroud 251 to base 202. These may be the same fastener components that are used to join actuator 216 and/or voice coil motor 218 to base 202. Fastener well shields 281, 283 substantially separate the interiors thereof from the actuator, and from area external to actuator shroud 251, in data storage device 200. Fasteners such as screws may then be inserted through fastener well shields 281, 283 and screwed into base 202, and even repeatedly unscrewed and re-screwed if need be, while any debris generated from such a fastening process that is not cleaned up by other routine cleanroom techniques, tend to be isolated and trapped within the fastener well shields 281, 283 for the performance lifetime of data storage device 200. The same may apply to other fastener mechanisms that may be used, which may include bolts, pins, pegs, clasps, clips, clamps, buckles, rivets, studs, grommets, battens, or any other type of fastener. As with the shroud as a whole, the fastener well shields 281, 283 may therefore also deny the capacity for such debris to be transported at a later time to the area of the discs 207 and to interfere with or damage the surfaces of the discs or the interface between the sliders or other read/write mechanisms and the disc surfaces.

FIG. 4 depicts another illustrative example of an actuator shroud 451, which is similar in some respects to actuator shroud 251 of FIGS. 1 through 3, and which may also be incorporated into a data storage system similar to that of FIGS. 1 and 2. Whereas actuator shroud 251 is depicted as being formed of a single, integrally formed material, actuator shroud 451 comprises two separately formed shroud portions 455, 457. This may provide advantages, for example, in allowing the individual shroud portions 455, 457 to be simpler to make and with simpler, more tolerant requirements for structural integrity, while the integrally formed configuration of actuator shroud 251 may provide advantages of avoiding an intermediate step of assembling different shroud portions together prior to mounting the actuator shroud in a data storage system.

Similarly to actuator shroud 251, actuator shroud 451 also includes shielding walls 471, 473, and 475, radially curved shroud wall segment 477, and fastener well shields 481, 483, as depicted in FIG. 4. Actuator shroud 451 also includes two separate support portions 470, 472, and another streamlining wall feature 477 extending outward from the exterior of actuator shroud 451. Wall feature 477 is configured to contiguously extend the streamlined external surface of shielding wall 471 toward other flow control devices upstream of actuator shroud 451, similarly to disc stack shrouds 261, 263 in FIG. 1, such that wall feature 477 contributes to a continuous, smooth flow path the upstream flow control surfaces to the flow path running along the shielding walls 471, 473 of actuator shroud 451, in this illustrative example.

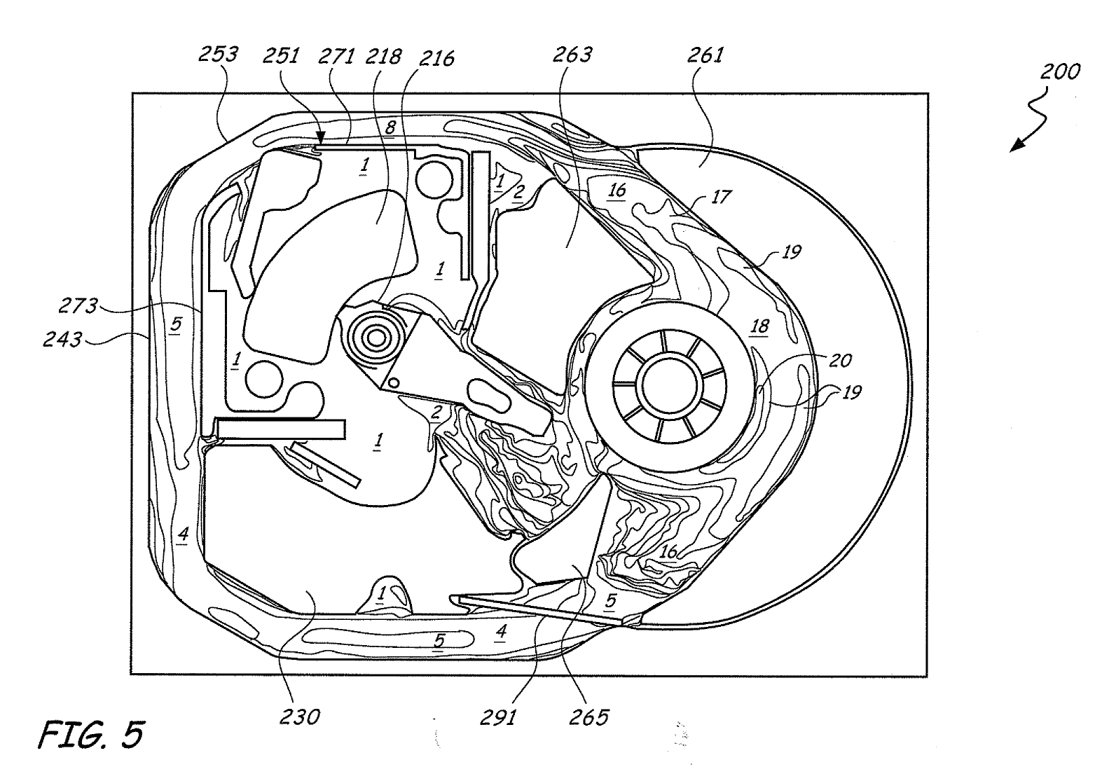

FIG. 5 depicts data storage system 200, along with a representation of flow rate within the system while it is operating, as generated with computational fluid dynamics (CFD) modeling. This representation is based on the disc stack 206 rotating at a rate of 15,000 revolutions per minute (RPM) under one illustrative example of specified operating conditions. In other examples, any other rotational speed may be used, lower or higher than the illustrative value of 15,000 RPM, within any design limitations analogous to the illustrative example of FIG. 5 with the materials and means that become known.

The rotation of the disc stack 206 motivates a circulating air flow within data storage system 200, represented in terms of contour lines separating regions of different flow rate These regions are labeled with reference labels that identify quantities that indicate the flow rate within each contoured region. These range from “1”, which indicates between 0 and 1.4 m/s (meters per second) flow rate, while “20” indicates between 26.6 and 28.0 m/s. The region of the disc stack 206 adjacent to its axis of rotation, on the side facing away from the region containing the actuator, contains the highest flow rates, labeled “18”, “19”, and “20”. At the same time, the region surrounding the actuator 216, the voice coil motor 218, and the actuator shroud 251, is dominated by the lowest level of flow rate, indicated with the label “1”, meaning extremely low flow rates, lower than 1.4 and potentially down to simply zero m/s. In effect, actuator shroud 251 turns the vicinity of actuator 216 and voice coil motor 218 into a virtual dead zone in the air flow pattern, while maintaining proper air flow in the vicinity of the discs 107 for suspension of the read and/or write heads adjacent thereto. The bypass flow channel region outside of shielding wall 271 is labeled with “8”, and the bypass flow channel region outside of shielding wall 273 is labeled with “5”, indicating that much higher flow rates are just outside those streamlined barriers, and are similar to what flow rates directly through the immediate vicinity of the actuator 216 and voice coil motor 218 might be, if it were not for the presence of actuator shroud 251.

Tests were also performed within the CFD modeling and with physical prototypes, for the release of microscopic debris in the vicinity of actuator 216 and voice coil motor 218 during operation of the data storage system 200. The modeling and the physical prototypes both confirmed that the pickup and transport of this debris in the air flow were greatly diminished, and for particles of size greater than about twenty microns, debris transport was virtually eliminated.

Actuator shroud 251 therefore provides an effective means to inhibit air flow in the vicinity of actuator 216 and voice coil motor 218; to inhibit the transport of debris from elsewhere within data storage system 200 into disc pack 206 where it might damage or degrade the performance of data storage system 200; and to reduce air flow and turbulence in the vicinities of the disc edges, the actuator, and the voice coil motor, each of which acts to enhance mechanical precision and reduce the risk of read and/or write positioning errors. By constraining air flow along the channel defined by the exterior walls of actuator shroud 251 and internal circuitry 230 on one side and base walls 241, 243 on the other side, this configuration also increases the air flow rate through air flow recirculation filter 291, thereby raising the efficiency with which air flow recirculation filter 291 traps any remaining debris that still might be picked up by the air flow through the bypass flow channel.

While actuator shroud 251 is depicted in a particular illustrative example in FIG. 5, its elements may also be embodied in a wide variety of other configurations in any other different types of systems that would also benefit from an actuator that is mechanically enshrouded and/or shielded from its surroundings, or that would benefit from the inhibition of air flow and debris transport.

While certain illustrative actuator assemblies, shrouds, and data storage systems incorporating an actuator shroud are described herein and depicted in the accompanying figures, they are intended not to indicate any limitations to the variety of configurations, but rather to provide illustrative examples of the variety and broader meaning encompassed by the claims provided below. It is to be understood that even though numerous characteristics and advantages of various aspects of the present disclosure have been set forth in the foregoing description, together with details of the structure and function of various configurations of the disclosure, this disclosure is illustrative only, and changes may be made in details, including in matters of structure and arrangement of parts within the principles of the present disclosure to the full extent indicated by the broad general meaning of the terms in which the appended claims are expressed. For example, an actuator shroud may be used in association with any technology for the storage and/or manipulation of data, including those involving magnetoresistance, giant magnetoresistance, colossal magnetoresistance, flash memory, optics, magneto-optics, photonics, spintronics, holography, and any other technology. In addition, the present disclosure is not limited to systems for storage or manipulation of data, but may also involve a shroud used in association with any component or device for which a shroud may inhibit hydrodynamic flow and/or passage of material between an interior portion and an exterior portion.

What is claimed is:

1. An actuator assembly comprising:
a base;
an actuator disposed on the base; and
a shroud disposed on the base around the actuator, wherein the shroud comprises one or more shroud walls disposed between the actuator and a flow channel exterior to the shroud.

2. The actuator assembly of claim 1, wherein the one or more shroud walls comprise one or more shielding walls that partially surround the actuator.

3. The actuator assembly of claim 2, wherein one or more of the shielding walls comprises a streamlined exterior surface.

4. The actuator assembly of claim 1, wherein the one or more shroud walls comprise one or more radially curved shroud wall segments.

5. The actuator assembly of claim 1, wherein the one or more shroud walls comprise one or more fastener well shields that substantially separate an interior thereof from the actuator.

6. The actuator assembly of claim 1, further comprising one or more streamlining features extending outward from an exterior of the shroud.

7. The actuator assembly of claim 1, wherein the shroud is composed of a single, integrally formed material.

8. The actuator assembly of claim 1, wherein the shroud comprises two or more separately formed shroud portions.

9. The actuator assembly of claim 1, wherein the shroud is composed of injection-molded plastic.

10. A shroud comprising;
a support portion;
one or more shielding walls attached to the support portion, the shielding walls defining an interior of the shroud and substantially separating the interior from a region exterior to the shroud; and
one or more fastener well shields attached to at least one of the support portion or one or more of the shielding walls, each of the fastener well shields substantially separating an interior thereof from the interior of the shroud and the region exterior to the shroud.

11. The shroud of claim 10, further comprising a radially curving shroud wall portion extending from the support portion.

12. The shroud of claim 10, further comprising a streamlining wall portion extending outward from the support portion such that it contiguously extends a streamlined external surface of one of the one or more shielding walls.

13. The shroud of claim 10, wherein the one or more of the shielding walls define a streamlined path around at least a portion of a perimeter of the shroud.

14. A data storage device comprising:
a base;
a disc stack comprising one or more discs rotatably mounted on the base;
an actuator, rotatably disposed on the base, and configured for supporting one or more data interface components in proximity to the one or more discs; and
an actuator shroud, partially surrounding the actuator, wherein the actuator shroud is configured to significantly separate the actuator from a portion of the data storage device exterior to the shroud.

15. The data storage device of claim 14, further defining a flow path motivated by rotating motion of the disc stack, the flow path passing through the disc stack and around the actuator shroud, wherein the actuator shroud comprises one or more streamlined shielding walls between the flow path and the actuator.

16. The data storage device of claim 15, further comprising one or more additional shrouds disposed in proximity to the discs, which direct the flow path into a general direction of the one or more streamlined shielding walls comprised in the actuator shroud.

17. The data storage device of claim 14, wherein the actuator shroud further comprises a shroud wall disposed between the actuator and the disc stack.

18. The data storage device of claim 17, wherein the shroud wall is radially curved in substantial conformity with a radial perimeter of the disc stack and disposed substantially adjacent to the disc stack.

19. The data storage device of claim 14, wherein the actuator shroud further comprises one or more fastener well shields each substantially separating an interior thereof from the actuator and from the portion of the data storage device exterior to the actuator shroud, wherein the actuator shroud is fixed to the base by one or more fasteners disposed through the fastener well shields.

20. The data storage device of claim 14, wherein the actuator shroud is disposed on at least one of the base, a magnet plate disposed on the base under the actuator, or a top cover disposed over the base.
